(19) United States
(12) Patent Application Publication
(10) Pub. No.: US 2001/0021917 A1
(43) Pub. Date: Sep. 13, 2001

(54) Electronic commerce system for updating information

(75) Inventor: Shoji Hatano, Inashiki-gun (JP)

Correspondence Address: BEYER WEAVER & THOMAS LLP, P.O. BOX 778, BERKELEY, CA, 94704-0778, US

(73) Assignee: DGC INSTITUTE CO., LTD

(21) Appl. No.: 09/800,380

(22) Filed: Mar. 5, 2001

(30) Foreign Application Priority Data
Mar. 8, 2000 (JP) 2000-62987(P)

(51) Int. Cl. G06F 17/60

(52) U.S. Cl. 705/26

(57) ABSTRACT

As the volume of electronic commerce transactions increases, the increase in exchanges with client systems places an excessive load on the entire system.

A purchasing process (STEP S108) is executed through internal processing by a client system 20 on the basis of HTML files and item information (STEPS S104, 106) downloaded from a WWW server 50. This process generates no communication whatsoever with the WWW server 50. This information is written to a temporary file (cookie). In the client system, when this file changes, a web browser screen is displayed or updated in accordance with the content of the file. Thus, a proper display reflecting, for example, selection of more than one unit of a given item, can be generated without communicating with the server system.

### BACKGROUND OF THE INVENTION

1. Field of the Invention

The present invention relates to an electronic commerce system for conducting electronic transactions between a server system and a client system over a network such as the Internet, to a server system and client system for use in such electronic commerce, and to a method for electronic commerce.

2. Description of the Related Art

In the context of the recent astounding expansion of networks, and of the Internet in particular, data communications in hypertext transfer protocol (HTTP) taking place between client systems and servers can be provided in the form of a graphical interface by creating viewable documents in hypertext markup language (HTML) which are posted on the server for access by any of various web browsers operated on the client. Hyperlinks, one of the capabilities of HTML, allows a client to easily go to desired information on the server simply by clicking with the mouse on a particular graphic or text. Server-client electronic transactions conducted utilizing this capability are a matter of great interest, due to the fact that transactions involving selection of items, quantities, and terms of payment can be completed instantaneously and electronically between a customer (the client) and a vendor (the server) without the need for manual procedures.

Where a JavaScript is embedded in an HTML file on a server, the script is interpreted and executed by the client's web browser, allowing the contents of HTML files to be changed by means of conditional branches reflecting the each client's entered information or selected menus/information, thereby allowing different pages to be displayed according to the specific interests of the customer. Temporary files (hereinbelow also referred to as “cookies”) that run on JavaScript is executed by the web browser when visiting particular domains, allowing information for individual clients to be registered, modified, or read. It is accordingly possible to set conditions for execution or interpretation of HTML files on the basis of conditions such as data previously entered into a particular server, or the dates, times, and number of visits to that server. Such an environment dramatically expands the possibilities for electronic transactions between clients and servers over the Internet.

In conventional electronic commerce, however, processes relating to transactions are basically performed on the server side, and thus as item selection and various stipulated conditions therefor (such as the quantity or color of a item, the specifics of a particular service, etc.) increase in number, the load imposed on the server side increases significantly. Viewed from the server side, the need to respond to requests from a multitude of clients arriving in distributed form over a network makes it difficult to provide specific client-tailored responses, while from the client side such conditions cannot be said to optimal for conducting transactions. Taking by way of example the case where one wishes to select for purchase an item displayed on a page, an arrangement termed a “shopping cart” currently enjoys widespread use. Each time that an item appearing on a page is selected, the item is registered on a list of items for possible purchase, and the total price is displayed. Computation of total price is performed on the server side. Specifically, the server system identifies the client from data received over the network and combines this with data collected up to this point to compute a total price, which is then sent to the client system. On the basis of the data received, the client system updates the total price display.

Where a client wishes to purchase two of a given item viewed on a item purchase page received from a server system, one possible method for doing so would be to click twice on the item shown on the page. However, since the server system performs distributed processing of a multitude of requests received over the network, it is extremely difficult for the server to determine that requests for a given item have been made by the same client, and so the server system treats the request as an additional new item. Thus, the same item appears in duplicate as different items in the shopping cart. As a result, ease of use is less than desirable for an electronic commerce system.

While viewed from the client side, the electronic commerce system may simply appear to be difficult to use, it is possible that at the same time excessive demands are being placed on the network. The Internet and other networks used for communication between servers and clients are typically public networks that are accessible to the public; in such networks, a fair communications environment is provided to all users through the use of packet transmission. Thus, as content (such as item or service descriptions) provided by a server is received by a greater number of customers (clients), i.e., as a greater number of clients wish to access the server, the time for which the server can allot processing for any single client becomes shorter, and server response speed drops. This runs counter to the desire of customers to complete electronic transactions instantaneously. Where specific client-tailored responses are needed, the amount of information that must be exchanged between a client system and a server system in order to make a single purchase increases considerably, and this greatly increases the load on the network.

In some instances a client may wish to run multiple web browsers (i.e., use a web browser with multiple windows open) in order to simultaneously perform electronic transactions with a given server. For example, where the content provided by the server is computer item-related information, the client may wish to conduct a transaction for computer hardware in one web browser window while conducting a transaction for computer software in another web browser window, or otherwise realize the potential advantages of electronic commerce.

HTML files stored on a server are individually read, interpreted, displayed, and processed by multiple web browsers run simultaneously by a client. Thus, despite the fact that these transactions are in actuality conducted between a single vendor (server) and a single customer (client), in electronic data terms the multiple web browsers are treated as if a plurality of customers were conducting transactions simultaneously. Accordingly, the client must view separate displayed prices for transactions conducted by each web browser and must make duplicate entry of customer credit card information, terms of payment, etc. The ease of use of this user interface is thus unsatisfactory.

### SUMMARY OF THE INVENTION

With the foregoing in view, it is an object of the present invention to provide an electronic commerce system that, while using the excellent electronic commerce environment provided by the Internet, does not increase server load and provides a user interface adapted to real-world transactions; a server system and client system for use in electronic commerce; and a method for electronic commerce.

To achieve this object, the electronic commerce system herein is

an electronic commerce system for use in electronic transactions conducted between a server system and a client system over a network such as the Internet, and performs the following processes. First, content relating to the subject of a transaction is downloaded from the server to the client system, and the content is displayed on the client system. On the basis of this display, the client enters transaction parameters necessary for completing the transaction, whereupon at least some of the transaction parameters are stored in a file in a storage device on the client system side. In the event of a change in the file, file contents are checked and the screen display on the client system side is updated. In other words, the client system can update the display of transaction parameters, such as the display of information such as the quantity of units ordered, total price, etc., without any exchange of information with the server via the network. Where a specific process is to be performed, after the client system has transmitted transaction parameters to the server system over the network, processing relating to updating of the screen is performed by the client system until the specific process is completed, thus reducing the load on the server. Since required information is held on the client system side, in the event that, for example, a given item has been clicked twice, it is a simple matter to determine that two of a given item have been ordered and to produce a display reflecting this. The server system receives the transmitted transaction parameters and completes the transaction with reference to these transaction parameters. Accordingly, the server system need only receive transaction parameters transmitted by a specific procedure, reducing the load on the server.

In conjunction with the electronic commerce system invention herein there are provided a server system and a client system invention for realizing such a system. The server system employs web server functionality to transmit to the client system hypertext markup language format files containing embedded JavaScript required on the client system side, and receives transaction parameters sent from the client system whereupon it completes the transaction. Accordingly, this server system can execute transactions on the basis of the transaction parameters last received from the client system side, without the need to respond immediately even if transaction parameters on the client system side have been changed. Server system design may be simplified as a result.

The client system herein downloads from the server to the client system side content relating to the subject of a transaction, and the content is displayed on the client system. On the basis of this display, the client enters transaction parameters necessary for completing the transaction, whereupon at least some of the transaction parameters are stored in a file in a storage device on the client system side. In the event of a change to the file, file contents are checked and the screen display on the client system side is updated. In other words, the client system can update the display of transaction parameters, such as the display of information such as the quantity of units ordered, total price, etc., without any exchange of information with the server via the network. Where a specific process is to be performed, after the client system has transmitted transaction parameters to the server system over the network, processing relating to updating of the screen is performed by the client system until the specific process is completed, thus reducing the load on the server. Since client system is typically composed of a computer, a program constituting these processes can be stored on a storage medium readable by the computer and subsequently read by the client system computer so that the functions thereof may be performed. This program is downloaded onto the client system computer over the network.

There follows a description of possible embodiments for the electronic commerce system, method for electronic commerce, server system, and client system herein. The server system employs a web server system to store hypertext markup language format files in which are embedded JavaScript required to perform the various aforementioned processes on the client system side; the client system at a minimum performs the web browser functions of executing hypertext transfer protocol, reading hypertext files stored on the web server system, and performing processes on the basis of JavaScript embedded in the hypertext files, to provide a system for performing the aforementioned processes. With this architecture it is possible to easily construct an electronic commerce system using existing Internet-centered technology enjoying widespread use, such as hypertext markup language and web server systems. Such a system will also be compatible with existing systems.

In the electronic commerce system herein, when downloaded content and input transaction parameters are handled by different frames and/or different browsers on the client system, transaction parameters input via different frames and/or different browsers may be combined into the aforementioned file for storage. In electronic transactions, content of various kinds is displayed on different screens appearing in multiple frames or windows; by using a single file as the file for storing this various information, client system side processes can be simplified and combined.

The ability to display in an independent window multiple items of information combined and stored in the aforementioned file also provides advantages in terms of ease of use on the client side. Independent window display requires correct determination on the client system side as to whether this window is already displayed. Possible means for making this determination follow. One such means employs a duplicate file which, while separate from the file storing the transaction conditions, is associated with this file; when an independent window showing transaction information is displayed, the contents of that file is copied to the duplicate file at predetermined intervals, and in the event that a new transaction parameter has been specified in the client system, the file is rewritten in accordance with the specified transaction parameter, and the content of the file is compared with that of the duplicate file. If the two do not match, a determination is made that an independent window showing this new transaction information is not displayed, and the aforementioned independent window is displayed. In an alternative design for enabling independent window display, when an independent window showing transaction information is displayed, random number are written to a predetermined storage area in the aforementioned file at predetermined intervals, and in the event that a new transaction parameter has been specified in the client system, the file is rewritten in accordance with the specified transaction parameter, and the contents of the predetermined storage area in the aforementioned file is read to determine if the content has rewritten; if the content has not been rewritten, a determination is made that an independent window showing this new transaction information is not displayed, and the aforementioned independent window is displayed.

The window showing the aforementioned transaction information may be displayed together with other windows. Transaction information is crucial information in electronic transactions, and where it can be displayed together with other windows, ease of use is improved further.

This file can be described as a cookie for managing the web browser run by the client system. A cookie is information stored on the client computer, and, using JavaScript, can be created, modified, deleted, or given an expiration date. Cookies are used by the server, more specifically, by a particular domain, via a web browser; the information therein is not used by other domains. Maximum file size is 4 KB, total entries are limited to 300, and a maximum of 20 items of information can be stored for a server or domain. A feature of such cookies is that they are ideal transaction information indicator means for managing, in the form of a single file, transaction information for a particular domain, and since JavaScript has standard functions provided, there is no need to develop new programs. Management on a per-domain basis by a web browser also assures privacy and security in transactions.

In preferred practice, transaction parameters received from the client side will be verified on the server side, and where the transaction parameters have been authenticated the transaction will be completed. Where there exists the possibility that transaction parameter may be modified in the course of processing on the client side or transmission over the network, it is advantageous in terms of electronic transaction security and reliability to provide a verification arrangement.

### BRIEF DESCRIPTION OF THE DRAWINGS

FIG. 1 is an illustrative diagram of a net pertaining to an embodiment of the invention whereby a client computer 20 and WWW server 30 are connected;

FIG. 2 is a flow chart showing communication between the client computer 20 and the WWW server 30;

FIG. 3 is a screen capture diagram of the web browser loaded on the client computer 20;

FIG. 4 is a flow chart of a JavaScript executed during itemion selection;

FIG. 5 is a flow chart of a JavaScript executed at predetermined time intervals;

FIG. 6 is a screen capture diagram of the web browser during purchase of Item 1;

FIG. 7 is a screen capture diagram of the web browser during purchase of Item 1 and Item 2;

FIG. 8 is a screen capture diagram of the web browser during purchase of Item 1, Item 2, and Item 3;

FIG. 9 is a screen capture diagram of the web browser during ordering;

FIG. 10 is a screen capture diagram of the screen wherein the shopping cart is displayed as a floating window 60;

FIG. 11 is a flow chart describing a script for handing floating window 60; and

FIG. 12 is a flow chart describing a script provided to the shopping cart window.

### DESCRIPTION OF THE PREFERRED EMBODIMENTS

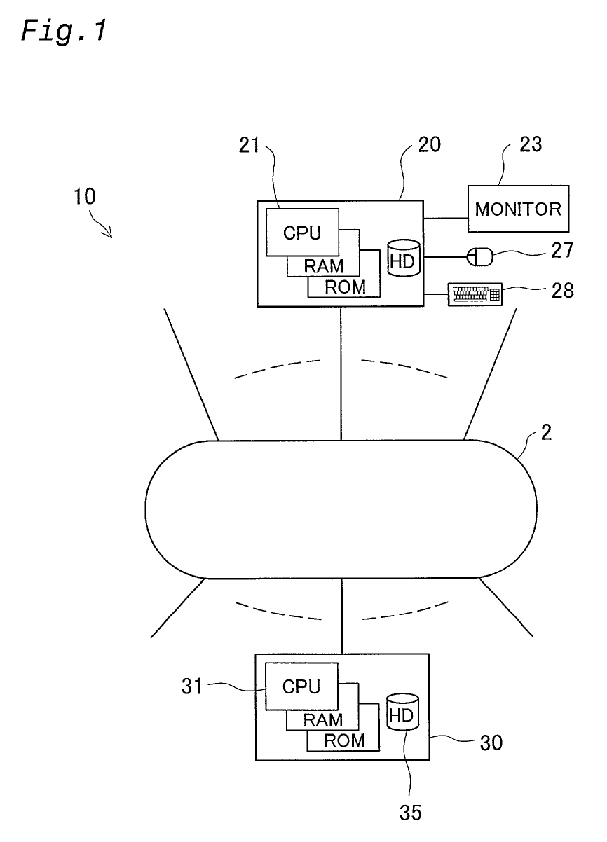

A fuller understanding of the constitution and working effects of the invention set forth herein above is provided through the following description of an electronic commerce system embodying the invention. FIG. 1 is a conceptual diagram of an electronic commerce system 10 pertaining to an embodiment of the invention. This electronic commerce system 10 comprises a client system (hereinbelow termed simply “client computer”) 20 and an electronic commerce server system (hereinbelow termed simply “WWW server”) 30, connected to each other via the Internet 2. In the following description, an individual performing transactions on client computer 20 is termed a “client.”

It is common knowledge that any arbitrary client computer 20 can connect to any arbitrary server over the Internet 2. While there are various ways to connect over the Internet, in the present discussion, server 30 is a web (WWW) server to which client computer 20 connects using the so-called HTTP protocol. The client computer 20 runs a web browser. Accordingly, one of the anonymous client computers 20 specifies the IP address of the WWW server 30 using a DNS server or the like, and is connected to this WWW server 30 to establish the electronic commerce system 10 of the present embodiment.

Once an arbitrary client computer 20 connected to the Internet 2 has specified a WWW server 30 and connected to it, the WWW server 30 allows the client computer 20 to read web pages created in HTML. The client computer's 20 web browser interprets and executes JavaScript embedded in the HTML files. The client computer 20 is an ordinary computer comprising a logical operation element, namely, a CPU 21; semiconductor storage elements (RAM, ROM); a hard disk 25; a network card (not shown) for executing TCP/IP network protocol for connecting to the Internet; and an interface for communicating with peripheral devices such as a monitor 23, mouse 27, and keyboard 28. The WWW server 30 is also an ordinary computer comprising a CPU 31, RAM, ROM, or a hard disk 35, etc. The hard disk 25 of the client computer 20 stores at a minimum a web browser, while the hard disk 35 of the WWW server 30 stores HTML web pages.

The client computer 20 loads and runs the web browser stored on its hard disk 25, whereby requests to the WWW server 30 from the client computer 20 are communicated based on hypertext transfer protocol (HTTP), a stateless protocol that can be processed independently, allowing it to access the WWW server 30 connected to the Internet 2 through TCP/IP network protocol. As will be described later, HTML information on the WWW server 30 and information indicated by hyperlinks contained in this information can thus be displayed in a graphical interface for easy access.

The WWW server 30 is a server accessible via hyperlinks contained in graphics or text, and like other WWW servers connected to the Internet 2, it can be accessed over the Internet 2 by means of an address represented by an ordinary universal resource locator (URL), allowing clients to view and access information created in HTML. The WWW server 30 may be any computer that can run an OS that supports HTML and common gateway interface. The WWW server 30 is connected to the Internet 2 via a dedicated line, and has the processing capacity to enable simultaneous access by multiple clients.

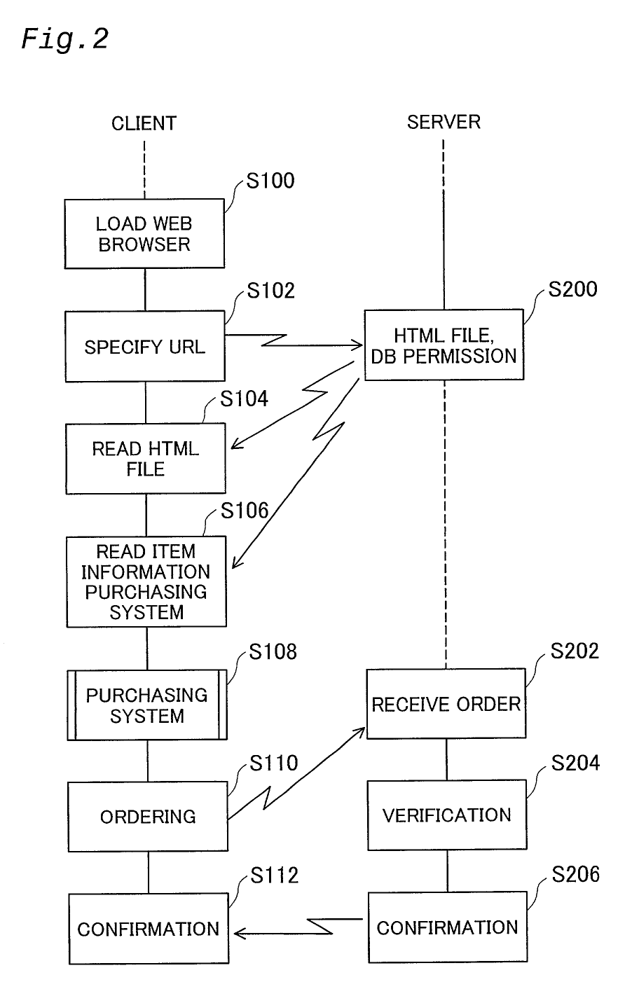

FIG. 2 is a flow chart of communication between such a client computer 20 and WWW server 30 via the Internet 2. When a web browser is run on the client computer 20 (STEP S100), the client computer 20 can now communicate via the Internet 2. When the URL address assigned to the WWW server 30 is entered in the web browser, communication with the WWW server 30 is established (STEP S102).

Where the WWW server 30 is accessible by anonymous users, it can be accessed by any arbitrary client computer 20, and where it is accessible only by registered clients, access is permitted only to client computers 20 identified by predetermined ID, permitting access to HTML files and information in item database (STEP S200). The client computer 20, upon receiving a reply from the WWW server 30, reads an HTML file (STEP S104) and downloads item information and a purchase system, described later (STEP S106). This purchase system is stored on the WWW server 30 and consists of JavaScript embedded in downloaded HTML files. In the present embodiment, a multitude of items are provided from the WWW server 30, and the HTML file and item database constitute separate information. Where the number of item offerings is relatively small, item information may be stored as a HTML file.

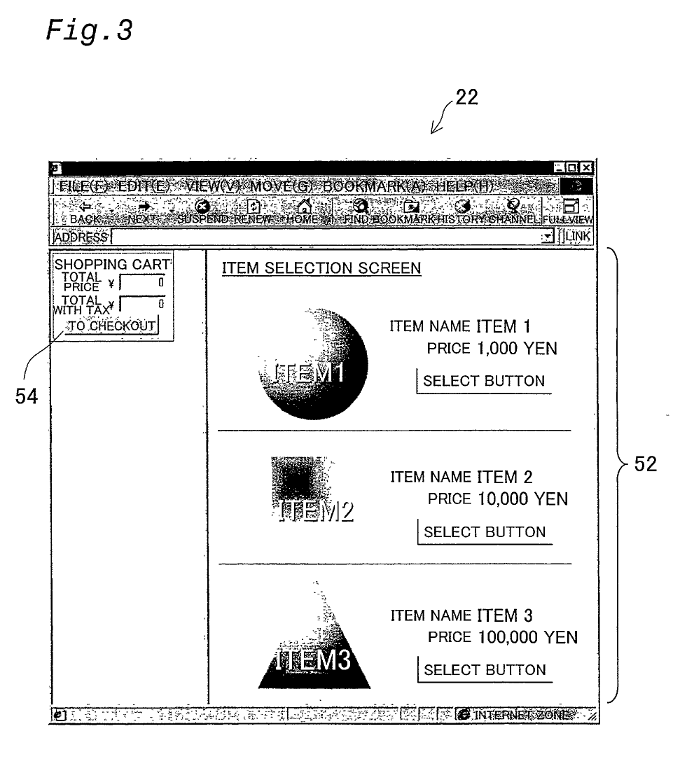

The client computer 20, having downloaded item information and the purchase system, is now able to execute a purchasing process (STEP S108) on the basis of this information. FIGS. 3 to 8 depict a more detailed flow chart of the purchasing process and examples of screens shown on the monitor 23 of client computer 20 during the process. In this purchasing process, a item information index 52 from the WWW server 30 is displayed, as shown in the screen capture diagram in FIG. 3. Using an input device provided to the client computer 20, such as the mouse 27 or keyboard 28, item selections, item quantities, and the like are entered. By executing the purchasing system, “total price” and “total with tax” are displayed in the web browser window 22 in a separate frame from the item information index display 52.

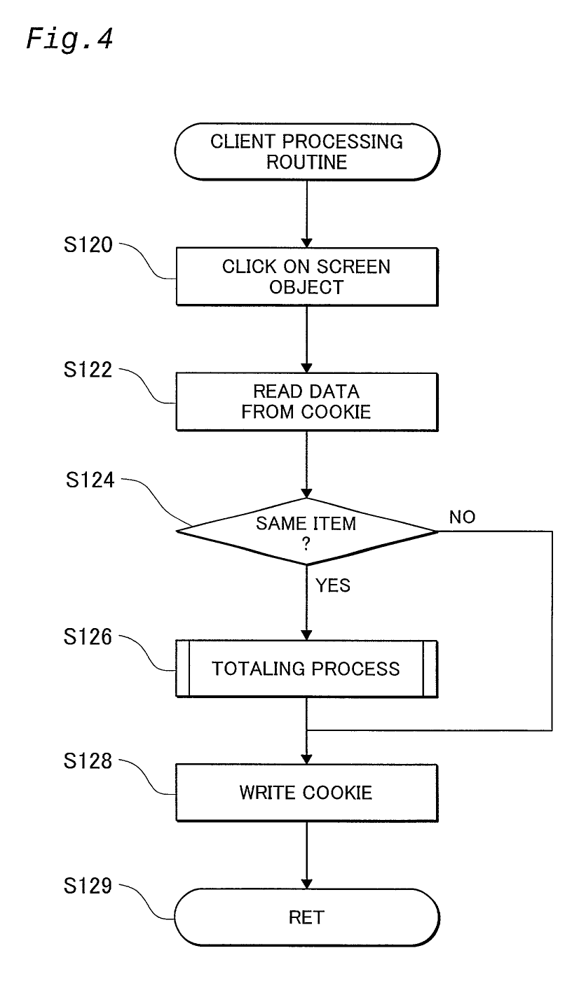

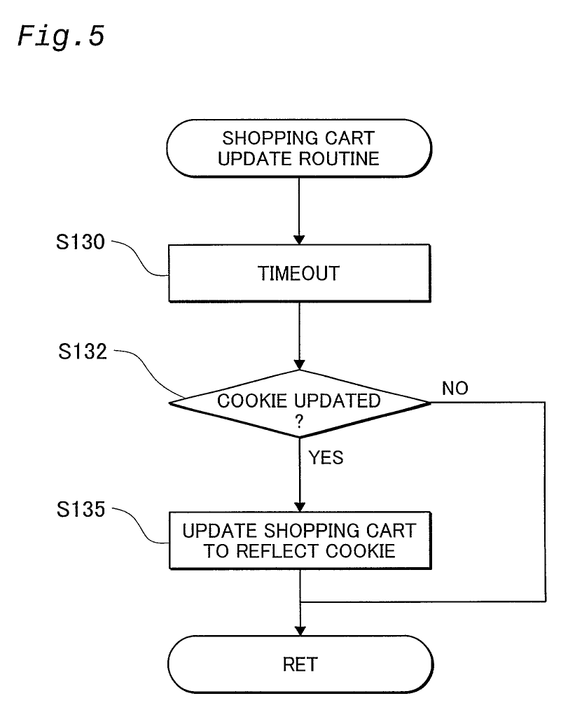

At this time, a JavaScript read by the client computer 20 is interpreted and executed by the web browser. FIGS. 4 and 5 are flow charts of the purchasing process executed by the JavaScript. When an object in the item information index 52 displayed on the monitor of the client computer 20, such as a Select button or a photograph, item name, or price of any of Items 1 to 3, is mouse clicked, this event triggers the JavaScript to run (STEP S120) as shown in FIG. 4, whereupon a file (cookie) stored in a specific folder on the hard disk 25 and associated with this WWW server 30 is read (STEP S122). Where the WWW server 30 is being contacted for the first time, no cookie is present and in such instances a new file will be created and opened. Where a cookie already exists, the content thereof will be examined to determine if a item identical to the currently selected item is already registered (STEP S124). If it is determined that this item is already present, a process for totaling the two is performed (STEP S126). In the example given previously, this totaling process will involve totaling data for each item, e.g., “Item 1” quantity —1, “Item 2” —quantity 2, etc. This totaling process is adapted not only to addition but also to subtraction. For example, where this routine is run by clicking on button to remove “Item 1”, data indicating “Item 1” would be deleted.

Next, all information for items placed in the shopping cart is stored in the cookie, and a process for closing the cookie (file) is then performed (STEP S128), completing the process (STEP 129). In the present embodiment, information created by item selection is stored using a cookie that can be handled in a standard manner by JavaScript, but where the file can be specified by the client computer 20, the information may be stored using a dedicated file other than a cookie. This file may be stored in a storage device other than the hard disk, such as floppy disk, RAM disk, or a portion of main memory.

On the client computer 20 side, meanwhile, the JavaScript shown in the flow chart in FIG. 5 is executed repeatedly. This JavaScript is run every 0.1 sec by means of a command such as setTimeout (STEP S130) to read data from the cookie and determine if it has been updated (STEP S132). If cookie data has not been updated, the current process is terminated. In the present embodiment, the time count is performed using a time function setTimeout contained in the JavaScript, but it would be alternatively possible to provide a counter that can be run by a JavaScript, and to monitor the value in the counter to detect when a predetermined time interval has elapsed and then run. Where data has been updated, on the other hand, a process for updating shopping cart 54 data in association with the contents of the cookie is performed (STEP S135). Updated data would include not only changes in itemion selection and/or quantities but also total price, tax, etc. for the items.

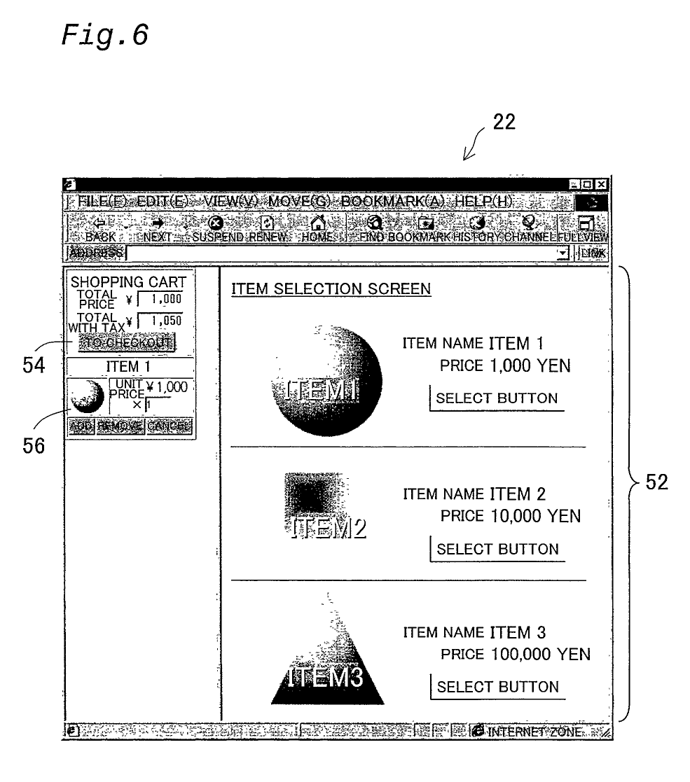

FIG. 6 is a screen capture diagram of the client computer 20 monitor in the event that Item 1 has been selected from the item information index 52. As shown in the figure, in the “Total Price” and “Total with Tax” fields of shopping cart 54 are shown totaled the price for purchase of a single unit of Item 1. In the present embodiment, the JavaScript has been written such that item purchase information 56 based on the item selections and purchase quantities registered in the cookie are displayed in the same frame as the shopping cart 54 to enable easy confirmation of the item purchase summary. The item purchase information 56 is further provided with three buttons, “Add,” “Remove,” and “Cancel”; these buttons when clicked with the mouse of the client computer 20 run JavaScript that generates triggers for increasing or decreasing the number of items for purchase or canceling a purchase transaction, and are programmed so that the cookie is updated as well. Item quantities can also be changed my moving the cursor to the field in which the quantity is displayed and entering a new quantity directly from the keyboard.

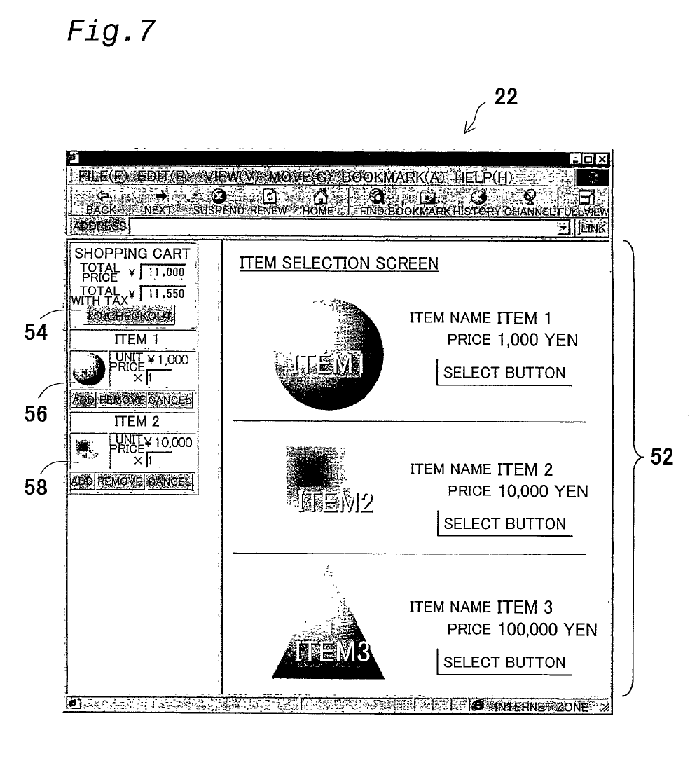

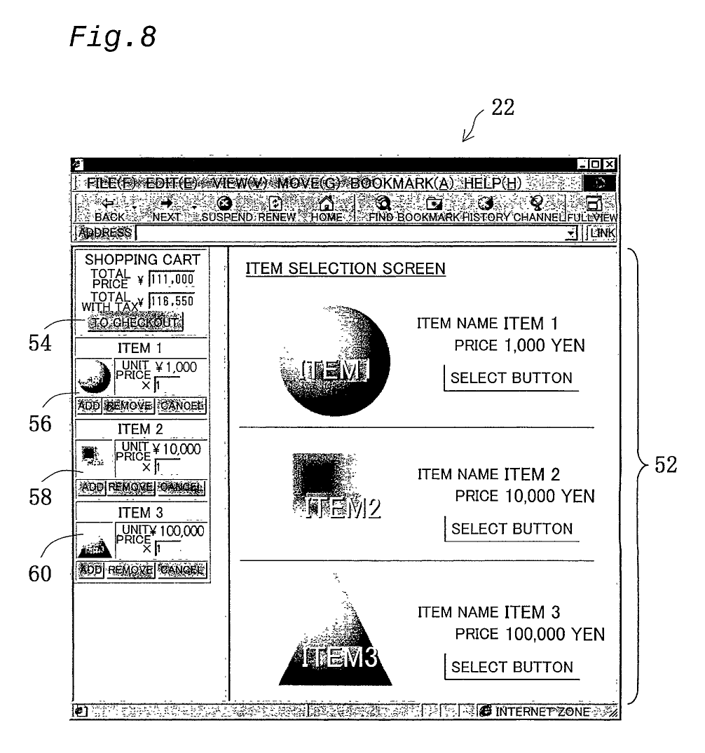

With a purchasing process of this kind (STEP S108), in the event that one unit each of Item 1 and Item 2 have been selected on the client computer 20, the shopping cart update routine indicated in FIG. 5 is run so that the web browser 22 on the monitor now shows the screen depicted in FIG. 7 wherein additional item purchase information 58 is displayed in the same frame as the shopping cart 54, with the unit price in shopping cart 54 updated. Similarly, an illustrative diagram of the web browser screen where one unit each of Item 1, Item 2, and Item 3 have been selected is shown in FIG. 8. Here, additional item purchase information 60 for Item 3 is shown, and the new price inclusive of the additional item is displayed in shopping cart 54. In the present embodiment, a totaling process (FIG. 4, STEP S126) is performed, so even if two or more units of the same item are selected, the increased number of items ordered will be displayed, rather than displaying the same item twice.

As will be apparent from the preceding description, this purchasing process (STEP S108) is executed internally by the client computer 20 on the basis of HTML files and item information downloaded from the WWW server 30, and as such does not require communication with the WWW server 30 to run (see FIG. 2). Accordingly, display and updating of the web browser screens shown in FIGS. 6 to 8 may be performed instantaneously through the information processing capability of the client computer 20 so that items for purchase may be added or removed, or purchases cancelled, in real time. Since processing for adding or removing items and canceling purchases are performed by the client computer 20, these processes do not impose an information processing load on the WWW server 30, allowing it to allot processing to other clients during this time so that faster service can be provided to multiple clients.

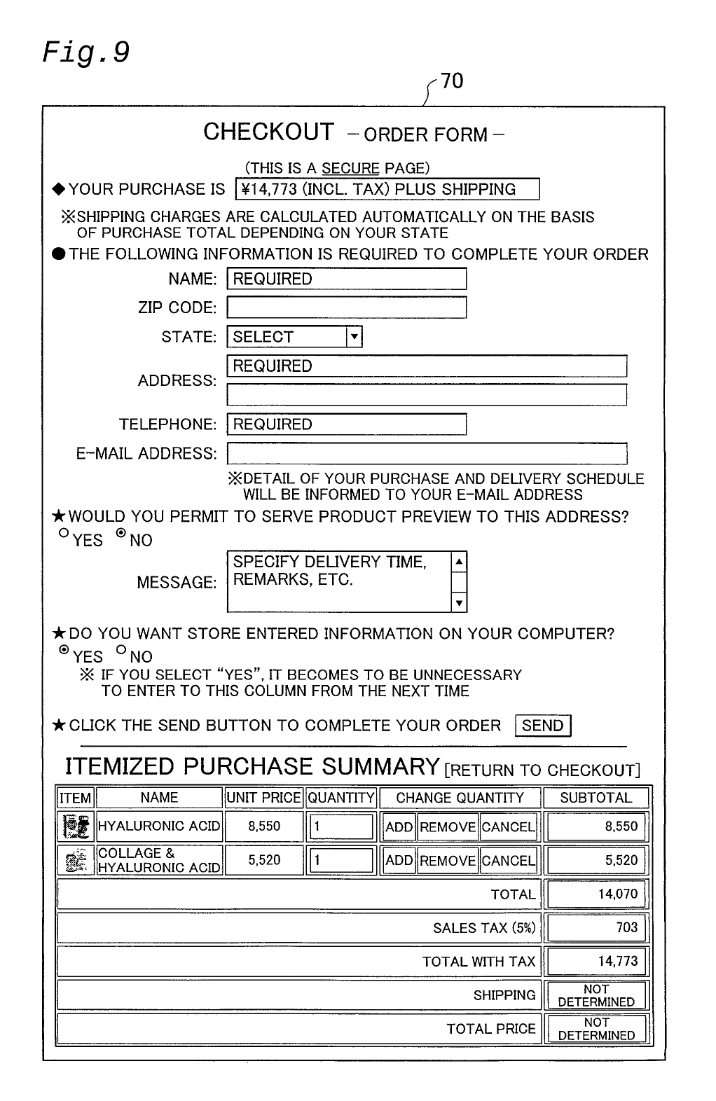

This purchasing process (STEP S108) terminates once the client computer 20 proceeds to the order process (STEP 110). Proceeding to the order process (STEP 110) refers herein to an event triggered by an input from the keyboard or mouse instructing the order to be sent to the WWW server 30. In the present embodiment, it is triggered by mouse clicking a “Go to Checkout” button in the shopping cart 54. When processing by the client computer 20 proceeds to the order process (STEP 110), the web browser 22 screen is refreshed to display the form shown in the screen capture diagram in FIG. 9, which shows total purchase price, itemized purchase confirmation, fields for entering customer information, and other necessary information. Once the required information has been entered in the form, a “Send” button is used to transmit the required item purchase information to the WWW server 30. In the present embodiment, there is also provided in the Itemized Purchase Confirmation field buttons for changing the quantity of items purchased and for deleting items, enhancing convenience at the client computer 20.

When the “Send” button on the client computer 20 side is clicked with the mouse 27, order information required for item purchases is sent from the client computer 20 to the WWW server 30 via the Internet 2. When the WWW server 30 subsequently receives this order information it performs an order receipt process (STEP S202) to verify that all required information is present, and then performs detailed verification of the contents of order information (STEP S204). Contents verification refers herein to detailed verification that the order information has been created on the basis of HTML files and item information transmitted by the WWW server 30, and verification of customer credit information and the like. The quantity of items ordered and the total price are confirmed as well. Once it has been determined through the verification process that the ordering information is correct, the WWW server 30 sends to the client computer 20 confirmation information confirming a establishment of a contract (STEP S206). The client computer 20 receiving this confirms establishment of the contract (STEP S112), whereupon the series of processes terminates.

According to the electronic commerce system of the present embodiment, it is therefore now possible to assure reliability and security in electronic transactions. Transactions conducted over the Internet 2 are in many cases less reliable than so-called face-to-face transactions, and the system is an extremely useful means for assuring reliability.

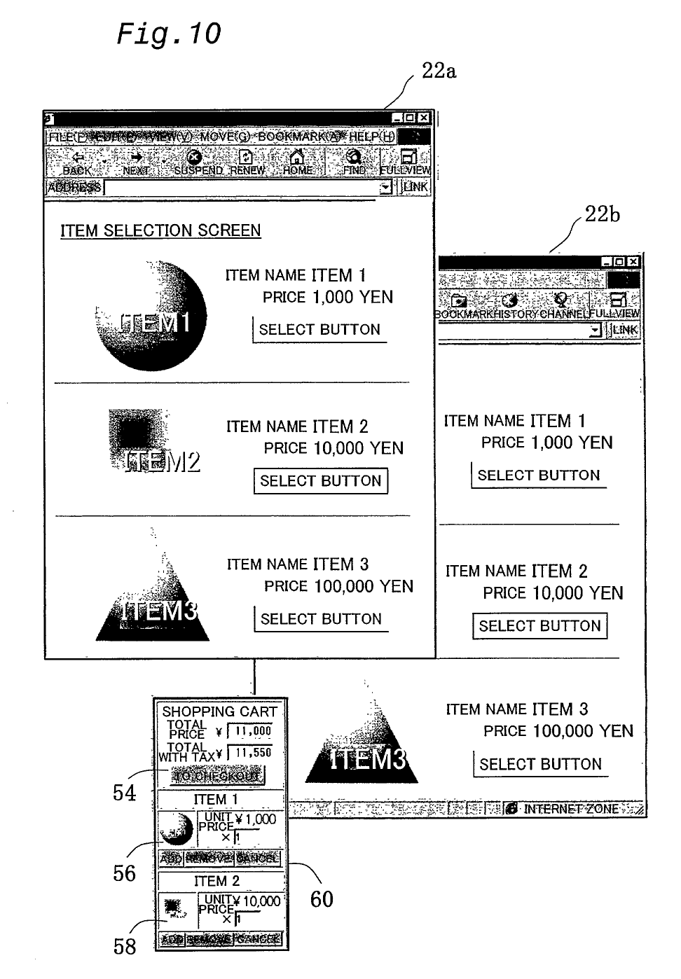

For example, while in the preceding embodiment, the shopping cart 54 is shown in the same web window as the item index 52, the shopping cart 54 and item purchase information 56, 58, 60 could be displayed in separate web windows. FIG. 10 is an illustrative diagram showing an example of a shopping cart displayed as a floating pallet 60. As shown in the figure, this shopping cart 60 is displayed in a separate window apart from the current web browser window on the client computer 20 side. This arrangement permits window size and position to be changed, further enhancing convenience at the client computer 20. In this case as well the cookie handled by the client computer 20 is a single file, and thus even if two windows 22a, 22b are open in the web browser on the client computer 20, only a single shopping cart is displayed. In actual practice, clients intent on performing electronic transactions frequently open two or more windows in order to get item information, and thus displaying the shopping cart in an independent window is typically preferable to displaying a shopping cart in each individual window, since the former approach provides a summary of intended purchases at that point in time. Further, where the shopping cart 54 is displayed as a separate window, larger item display windows can be displayed on the monitor 23. That is, with a small window on monitor 23, one may in some instances wish to resize the item display window to make it larger, even where this means temporarily hiding the shopping cart. Whenever item selection is made, the shopping cart is displayed on top, allowing one to confirm the current state of purchases. Where monitor 23 has a screen of sufficiently large size, one may wish to display the shopping cart together with other windows. In such cases, information such as the quantity and total prices of items for purchases is displayed constantly for easy confirmation.

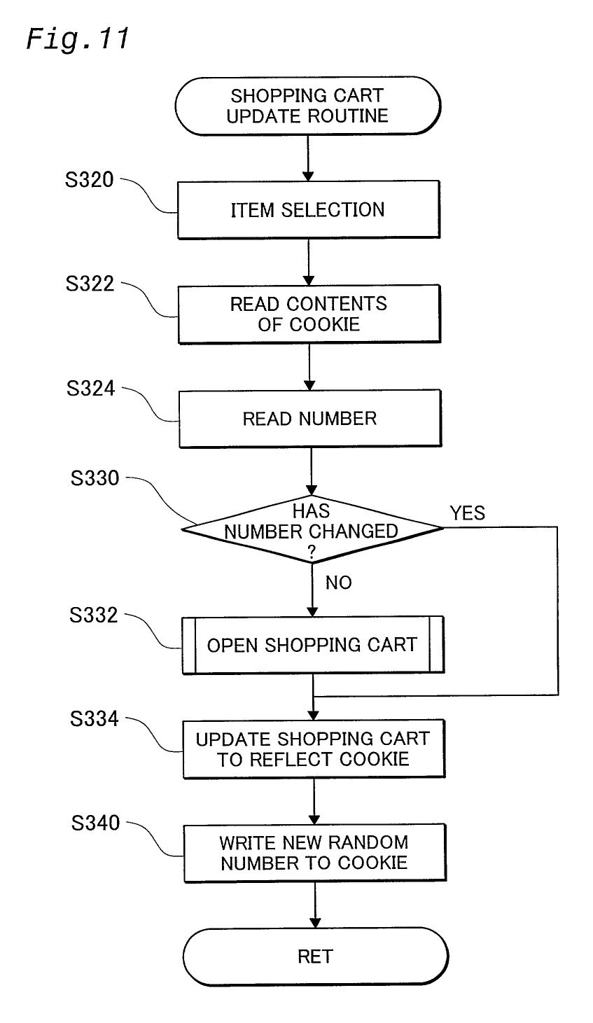

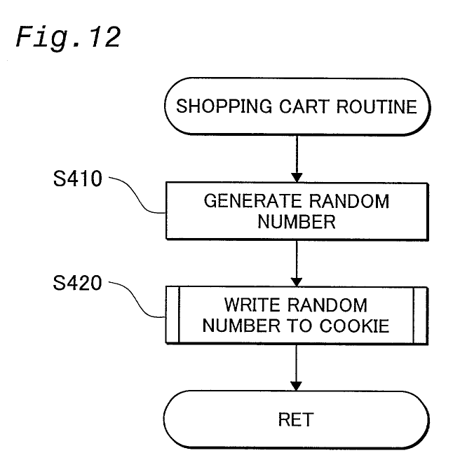

A method for displaying the shopping cart in a separate window is now described referring to FIGS. 11 and 12. In the web browser being run by the client computer 20, the process described by a JavaScript shown in FIG. 11 is executed repeatedly. The point of this process is to write a random number to a cookie by means of a JavaScript executed by the web browser. When a item has been selected on the web browser (STEP S320), the contents of a cookie—a file associated with the shopping cart—are read out (STEP S322), and a process for reading out a number that has been written to a predetermined location in the file is performed (STEP S324). This read out number is a random number that has been written in each of two processes described later; where this number has not changed since the one written previously at the end of this repeatedly executed routine (STEP S340), a determination is made that a shopping cart has not yet been opened (STEP S330). In actual practice, to assure accurate determination the determination that a shopping cart has not yet been opened is made only after determining that no rewrite has occurred over several cycles. Once the determination has been made, a shopping cart window is opened and rendered on the monitor (STEP S332), and made to reflect the contents of the cookie (STEP S334). Finally, a new random number is written to the cookie (STEP S340) and the system returns to the main routine.

Once a shopping cart window has been opened, this window has an appended JavaScript, and the process shown in FIG. 12 is executed repeatedly. Specifically, a random number is generated at predetermined intervals (every 100 msec, for example) (STEP S410), and this random number is written to the cookie (STEP S420). Thus, once a shopping cart window has been opened, the determination in STEP S330 in the process depicted in FIG. 11 is “YES,” and it is determined that a shopping cart window is open. With this arrangement, if the window displaying the shopping cart is active, the contents of the cookie are changed by writing a random number thereto at predetermined intervals, making it possible to determine by means of a simple device whether the shopping cart window is open. In this way a single shopping cart can be constantly displayed, and even if, for example, a item purchase process is initiated with multiple windows open, items previously placed in the shopping cart can be confirmed at a glance.

Where the preceding process has been designed such that, even if a shopping cart has not previously been displayed, a random number is written to the cookie when a item selection is made (FIG. 11, STEP S340), writing this number to a predetermined location in the cookie and setting this number to a predetermined value by default, it is possible to determine whether a shopping cart window is being displayed simply by writing random numbers to the shopping cart window side. in a modification of this embodiment, a single shopping cart window can be displayed using the following arrangement. A JavaScript is created for the window displaying the shopping cart and for the item display window, and a reference file separate from the cookie file storing transaction parameters such as item quantity, etc., but associated with this cookie is created. For purposes of discussion, the ordinarily used cookie is termed the “main cookie” and the file associated therewith is termed the “subcookie.” The independent window for displaying the shopping cart is provided with a script that, when this window is active (i.e., being displayed), copies the contents of the main cookie to the subcookie at predetermined intervals. The window displaying the item index 52 showing items, etc., on the other hand, is provided with a script that, in the event that a item is clicked on, or a new transaction parameter is otherwise specified, performs, depending on item selection and other factors, the totaling process used when the same item has been selected, a main cookie update process, etc., as in the embodiment described earlier (see FIG. 4). In addition to this script, this client side window is also provided with a script for comparing the contents of the main cookie with the contents of the subcookie, and where the two match, making the determination that no shopping cart window is open, and performing a process for displaying a shopping cart window.

With this arrangement, if the window displaying the shopping cart is active, the contents of the main cookie and subcookie will be identical, making it possible to determine by a simple device whether the window displaying the shopping cart is active or not. Thus, a single shopping cart can be constantly displayed, and even if, for example, a item purchase process is initiated with multiple windows open, items previously placed in the shopping cart can be confirmed at a glance.

The preceding embodiments are not limiting of the invention, various modifications thereof being possible without departing from the scope of the invention.

What is claimed is:

1. An electronic commerce system for conducting electronic transactions between a server system and a client system over a network such as the Internet, comprising:
download means for downloading to said client system via said network content comprising items and/or services provided from said server system;
parameter input means for entering into said client system client-side transaction parameters needed to complete a transaction relating to said content acquired via said download means;
file storage means for storing at least a portion of said transaction parameters entered via said parameter input means, said parameters being stored in a storage device provided on said client system side;
screen display update means for referring to the contents of said file and updating the screen display on said client system side in the event that said file is rewritten;
transmission means for transmitting said transaction parameters to said server system side via said network by means of a predetermined process on the client system side; and
transaction completing means provided to said server system for receiving said transmitted transaction parameters and completing the transaction on the basis of the received transaction parameters.

2. The electronic commerce system according to claim 1, wherein the server system is a web server system having stored therein hypertext files in hypertext markup language format containing embedded JavaScript for operating the client system as said download means, said parameter input means, said file storage means, said screen display update means, and said transmission means; and
the client system is a system that runs a web browser that executes at least hypertext transfer protocol, reads said hypertext files placed on said web server system, and carries out process on the basis of JavaScript embedded in said hypertext files in order to perform the functions of said download means, said parameter input means, said file storage means, said screen display update means, and said transmission means.

3. The electronic commerce system according to claim 1, wherein said file storage means combines transaction parameters in different frames and/or different browsers and stores in a file, when said content downloaded by said download means and transaction parameters entered via said parameter input means are handled by said different frames and/or said different browsers in said client system.

4. The electronic commerce system according to claim 3 wherein said screen display update means displays in an independent window a plurality of items of transaction information combined and stored in said file.

5. The electronic commerce system according to claim 4 further comprising:
a duplicate file separate from said file but associated with said file;
copying means for copying the contents of said file to said duplicate file at predetermined intervals when transaction information is displayed in an independent window; and
means for, in the event that a new transaction parameter has been specified in said client system, writing said specified transaction parameter to said file; comparing the contents of said file with said duplicate file; where the two do not match, determining that an independent window displaying said transaction information is not displayed; and displaying said independent window.

6. The electronic commerce system according to claim 4, further comprising:
random number writing means for writing random numbers to a predetermined location in said file at predetermined intervals when transaction information is displayed in an independent window;
rewrite determining means for, in the event that a new transaction parameter has been specified in said client system, writing to said file in accordance with said specified transaction parameter; and reading the contents of said predetermined location in said file to determine whether said contents have been changed; and
display initiating means for determining that independent window displaying said transaction information is not displayed in the event that said contents have not changed; and displaying said independent window.

7. The electronic commerce system according to claim 2 wherein said file storage means describes said file as a cookie managed by said web browser run on said client system.

8. The electronic commerce system according to claim 1 wherein said transaction completing means verifies said received transaction parameters and completes the transaction when said transaction parameters have been verified.

9. An electronic commerce system server system constituting part of the electronic commerce system according to any of claims 1 to 7 for conducting electronic transactions over a network such as the Internet, comprising:
means functioning as a web server;
means for transmitting to said client system files in hypertext markup language format containing embedded JavaScript for operating the client system as said download means, said parameter input means, said file storage means, said screen display update means, and said transmission means; and
transaction completing means for receiving transaction parameters transmitted from said client system via said network, and completing the transaction on the basis of said received transaction parameters.

10. A client system for use in electronic transactions with a server system over a network such as the Internet, comprising:
receiving means for receiving content consisting of items and/or services provided by said server system over said network;
parameter input means for entering transaction parameters needed to complete a transaction relating to said content acquired via said download means;
file storage means for storing in a storage device at least a portion of said transaction parameters entered via said parameter input means;
screen display update means for referring to the contents of said file and updating the screen display on the monitor in the event that said file changes; and
transmission means for transmitting said transaction parameters to said server system side via said network by means of a predetermined process.

11. A computer program product stored on a computer readable medium, for a client system of electronic transactions with a server system over a network such as the Internet, comprising:
code that receives content consisting of items and/or services provided by said server system over said network;
code that enters transaction parameters needed to complete a transaction relating to acquired said content;
code that stores in a storage device at least a portion of said entered transaction parameters;
code that refers to the contents of said file and updating the screen display on the monitor in the event that said file changes; and
code that transmits said transaction parameters to said server system side via said network by means of a predetermined process.

12. A method for electronic commerce conducted between a server system and a client system over a network such as the Internet, comprising the steps of:
downloading to said client system content consisting of items and/or services provided by said server system over said network;
entering into the client system side client-side transaction parameters needed to complete a transaction relating to said content acquired via said download;
storing at least a portion of said entered transaction parameters in a storage device provided on said client system side;
referring to the contents of said file and updating the screen display on said client system in the event that said file changes;
transmitting said transaction parameters to said server system via said network by means of a predetermined process on said client system side; and
receiving said transmitted transaction parameters at said server system and completing the transaction on the basis of the received transaction parameters.

13. The method for electronic commerce according to claim 12 further comprising the steps of:
initially receiving transaction parameters transmitted to said server system over said network; and
verifying said received transaction parameters and completing the transaction when said transaction parameters have been confirmed.
